(19) United States
(12) Patent Application Publication
(10) Pub. No.: US 2026/0320456 A1
(43) Pub. Date: Oct. 15, 2026

(54) METHODS AND APPARATUSES FOR EMULATING AN ION EMISSION

(71) Applicant: IonQ, Inc., College Park, MD (US)

(72) Inventors: John Joseph VETICK, East Windsor, NJ (US); Tan LIU, Frederick, MD (US); Nathaniel Tavis PRANGER, Skyesville, MD (US)

(21) Appl. No.: 19/637,875

(22) Filed: Apr. 2, 2026

Related U.S. Application Data
(60) Provisional application No. 63/789,239, filed on Apr. 15, 2025.

(51) Int. Cl. G06N 10/20; G21K 1/20

(52) U.S. Cl. CPC G06N 10/20; G21K 1/20

(57) ABSTRACT

Aspects of the disclosure may include a emulation system for simulating a trapped ion, comprising: a light source disposed on a first mount and configured to provide a first light, a first objective disposed on a second mount and having one or more first lenses and an aperture, a second objective disposed on a third mount and having one or more second lenses, and a controller having: one or more memories having instructions, one or more processors configured to execute the instructions to: cause the first objective to collimate the first light to produce a second light, perform in-plane alignment and focal plane alignment to an imaging system using at least a portion of the second light, cause the second objective to focus the second light into a third light, provide the third light as the simulated trapped ion to the imaging system.

### CROSS-REFERENCE TO RELATED APPLICATIONS

The current application claims priority to, and the benefit of, U.S. Provisional Application No. 63/789,239 , filed Apr. 15, 2025 and entitled “METHODS AND APPARATUSES FOR EMULATING AN ION EMISSION,” the contents of which are hereby incorporated by reference in their entireties.

### TECHNICAL FIELD

The current application relates to emulating an ion.

### BACKGROUND

Aspects of the present disclosure relates to an efficient and scalable method for production of trapped ion quantum computing imaging systems. The conventional approach employs the use of trapped ions for validation, but this is resource-intensive, and limits scalability and reproducibility because a trapped ion system, and the associated infrastructure and/or hardware, are necessary for calibration. This creates a bottleneck into both mass production and fast iterative development. Ions have been used because they are a true point source and uniquely emit isotropically, overfilling the field of view of the imaging system. As such, there is a need to provide a system for validating optics without the need to deploy trapped ions.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure may include a emulation system for simulating a trapped ion, comprising: a light source disposed on a first mount and configured to provide a first light, a first objective disposed on a second mount and having one or more first lenses and an aperture, a second objective disposed on a third mount and having one or more second lenses, and a controller having: one or more memories having instructions, one or more processors configured to execute the instructions to: cause the first objective to collimate the first light to produce a second light, perform in-plane alignment and focal plane alignment to an imaging system using at least a portion of the second light, cause the second objective to focus the second light into a third light, provide the third light as the simulated trapped ion to the imaging system.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of an emulation system for simulating an ion according to aspects of the present disclosure.

FIG. 2 illustrates a first configuration for aligning the emulation system according to aspects of the present disclosure.

FIG. 3 illustrates a second configuration for aligning the emulation system according to aspects of the present disclosure.

FIG. 4 illustrates a third configuration for emulating a trapped ion according to aspects of the present disclosure.

FIG. 5 illustrates an example of a computer system according to aspects of the present disclosure.

FIG. 6 illustrates an example of a method for simulating a trapped ion according to various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

An aspect of the present disclosure provides a source for calibrating the imaging system of a quantum computer without the need for the complicated process of creating a trapped ion. An optical system may be implemented to evaluate the imaging system build as a standalone optical system to make the subsystem production modularized.

As quantum computing is still developing, well-established solutions to various challenges have yet to emerge. Existing solutions to emulating ion emission often utilize fiber optic tips or mechanical apertures. A fiber optic tip based system may have a non-point like beam size, as well as suffering from a low numerical aperture (NA) and thus can't be used to evaluate the performance of the entire field-of-view of a large NA imaging system. Further, a conventional fiber optic based system would suffer from challenging alignment issues and lack of ability to perform full field measurements without a complicated scanning system.

Mechanical aperture based systems can achieve the necessary beam sizes, but they generate unwanted sidelobes around the main spot and could lead to wrong interpretation of imaging system performance (i.e. worse PSF, higher crosstalk). Additionally, they will reduce the power levels through the system significantly to an unusable point and suffer from costly custom lithography fabrication techniques.

Aspects of the present disclosure include a validation method using an optical system to emulate ion behavior, enabling validation without the need for a fully operational quantum computer. The concept employs a focused spot that is optically indistinguishable from an ion point source. A laser beam is simultaneously used for alignment and validation of the system and utilizes a configurable base for additional verification steps.

Aspects of the present disclosure further include a configurable mounting plate for the system, where multiple tests may be applied by swapping among a thin beam, a thick beam, an ion simulant, a transmission verification, a magnification, and/or a beam profiling. Aspects of the present disclosure include a tooling plate that may be mounted on a multiple degree-of-freedom (DOF) stage at the nominal height of the imaging system referencing each part of the tooling directly to the imaging plate via a tool that references the ion simulant baseplate.

In the emulation system, a thin beam is for the nominal alignment of the XY plane (i.e., plane normal to the direction of the beam) of the input to the imager assembly. The thin beam may be generated by using an aperture to “stop down” the input beam. A thick beam is for the nominal alignment of the Z plane (i.e., along the optical axis) of the input to the imager assembly. After alignment, the ion simulant is assembled along the microscope objective of the system. The ion simulant may use a high NA lens to simulate the isotropic emission of an ion (i.e., the ion simulant and a trapped ion may have an optically indistinguishable spot size). By using the ion simulant, one can achieve a practical measure of performance which represents an ions path through the system. This may allow an operator to assess the optical performance of the imaging system as it is related to ions.

In some aspects, the magnification plate that is back illuminated. This allows the magnification adjustment in the system to be validated. The beam profiling plate is to measure the beam sizes of reverse propagating beams for charging ions, which allows the quantification of beam metrics.

An aspect of the present disclosure includes an emulation system configured to simulate the emission of a trapped ion. The emulation system may include a light source configured to provide a light. For example, the light source may include a fiber input configured to provide a laser beam as the light. The emulation system may include a first objective configured to collimate the light source. The emulation system may include a plurality of second objectives configured to provide alignment, calibrations, and/or ion simulation. The emulation system may include one or more multi degree-of-freedom (DOF) stages configured to adjust the positions of the fiber input.

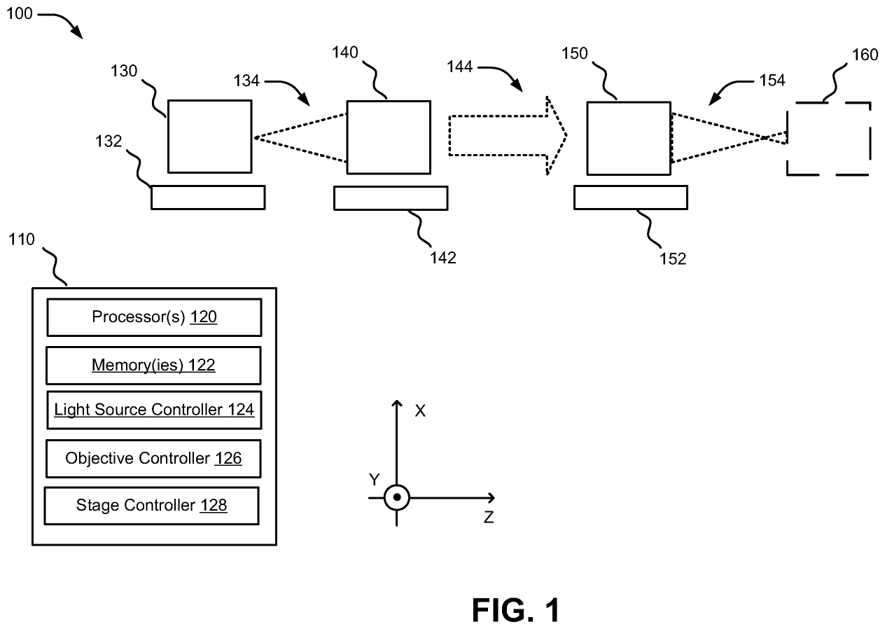

FIG. 1 illustrates an example of a schematic diagram of an emulation system according to aspects of the present disclosure. An emulation system 100 may include a light source 130. In one aspect, the light source 130 may include a fiber configured to guide a light from an emitter (e.g., laser beam, not shown in FIG. 1) into the emulation system 100. The laser beam may emit light having a spectrum that overlaps with the emission spectrum of a trapped ion to be simulated. In one aspect, the light source 130 may include one or more color filters configured to filter the light beam to adjust its emission spectrum to substantially identical to the emission spectrum of the trapped ion to be simulated. In certain aspects, the light source 130 may include one or more neutral density filters.

In some aspects of the present disclosure, the emulation system 100 may include a first mount 132. The light source 130 may be mounted on the first mount 132 with multiple DOF. Specifically, the first mount 132 may be configured to move the light source 130 in one or more directions along the x-axis, the y-axis, and/or the y-axis, and/or rotate the light source 130 in one or more directions around the x-axis (yaw), the y-axis (pitch), and/or the y-axis (roll). The first mount 132 may include one or more motors configured to move the first mount 132 as described above.

In certain aspects of the present disclosure, the light source 130 may be configured to emit first light 134. The emulation system 100 may include a first objective 140 configured to receive the first light 134. The first objective 140 may include a collimator configured to collimate the first light 134. In certain aspects of the present disclosure, the first objective 140 may include an aperture configured to restrict an amount of the first light 134 passing through the first objective 140. The first objective 140 may generate a second light 144, which is discussed in further details below.

In some aspects of the present disclosure, the emulation system 100 may include a second mount 142. The first objective 140 may be mounted on the second mount 142 with multiple DOF. Specifically, the second mount 142 may be configured to move the first objective 140 in one or more directions along the x-axis, the y-axis, and/or the y-axis, and/or rotate the first objective 140 in one or more directions around the x-axis (yaw), the y-axis (pitch), and/or the y-axis (roll). The second mount 142 may include one or more motors configured to move the second mount 142 as described above.

In certain aspects of the present disclosure, the emulation system 100 may include a second objective 150 configured to receive the second light 144. The second objective 150 may be configured to convert the second light 144 into a third light 154. The third light 154 may be focused to simulate an ion as described below. The second objective 150 may provide the third light 154 to a imaging system 160 configured to optically capture the states of trapped ions and/or the simulated ion based on the third light 154.

In one aspect of the present disclosure, the emulation system 100 may include a third mount 152. The second objective 150 may be mounted on the third mount 152 with multiple DOF. Specifically, the third mount 152 may be configured to move the second objective 150 in one or more directions along the x-axis, the y-axis, and/or the y-axis, and/or rotate the second objective 150 in one or more directions around the x-axis (yaw), the y-axis (pitch), and/or the y-axis (roll). The third mount 152 may include one or more motors configured to move the third mount 152 as described above.

In certain aspects of the present disclosure, the emulation system 100 may include a controller 110 configured to control various components of the emulation system 100. The controller 110 one or more processors 120 configured to execute instructions stored in one or more memories 122. The controller 110 may include the one or more memories 122 configured to store executable instructions for implementing various features of the present disclosure.

In some aspects, the controller 110 may include a light source controller 124 configured to control the light source 130. For example, the light source controller 124 may be configured to control the intensity, wavelength, duration, emission angle, and/or other parameters associated with the first light 134.

In one aspect, the controller 110 may include an objective controller 126 configured to control one or more of the first objective 140 and/or the second objective 150. For example, the objective controller 126 may be configured to control the aperture of the first objective 140. The objective controller 126 may be configured to add or remove the second objective 150.

In certain aspects, the controller 110 may include a stage controller 128 configured to control one or more of the first mount 132, the second mount 142, and/or the third mount 152. For example, the stage controller 128 may be configured to control the movements of one or more of the first mount 132, the second mount 142, and/or the third mount 152 in one or more directions along the x-axis, the y-axis, and/or the y-axis, and/or around the x-axis (yaw), the y-axis (pitch), and/or the y-axis (roll).

In an aspect, the controller 110 may be configured to transmit one or more control signals to the light source 130, the first mount 132, the first objective 140, the second mount 142, the second objective 150, and/or the third objective 152. The controller 110 may be configured to transmit the one or more control signals via wired or wireless channels. For example, the controller 110 may be configured to transmit the one or more control signals using copper wires, fiber optics, and/or atmosphere.

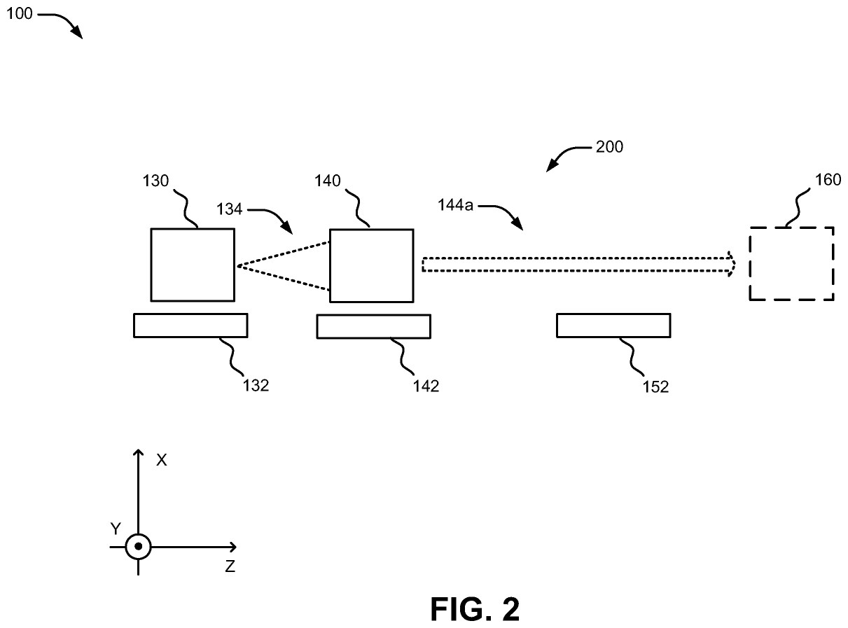

FIG. 2 illustrates a first configuration for aligning the emulation system according to aspects of the present disclosure. A first configuration 200 of the emulation system 100 may be configured for in-plane alignment. In some aspects of the present disclosure and referring to FIGS. 1 and 2, in the first configuration 200, the first objective 140 may receive the first light 134. The controller 110 may provide one or more mount control signals to the first mount 132 and/or the second mount 142 to align the light source 130 and the first objective 140.

In some aspects, the first objective 140 may include one or more lenses configured to collimate the first light 134 into the second light 144 (a collimated beam). The controller 110 may transmit one or more first objective signals to adjust the aperture in the first objective 140. Specifically, the controller 110 may transmit the one or more first objective signals to the first objective 140 to insert an aperture (such as a pin hole aperture) to generate a thin second light 144a (a constricted light). The thin second light 144a may be much smaller than the collimated second light 144. For example, the aperture may restrict 90%, 95%, 99%, or other percentage, of the collimated second light 144. The thin second light 144a may be used to align the light source 130 and/or the first objective 140 to the imaging system 160. The thin second light 144a may be used for in-plane alignment (i.e., along the plane span by the x-axis and the y-axis) by the imaging system 160. In the first configuration 200, the second objective 150 may be removed and/or disabled such that the second objective 150 does not impact the thin second light 144a.

In alternative aspects of the present disclosure, an aperture may be fixedly disposed along the beam path. To generate the thin second light 144a, the first objective 140 may control the diaphragm of the aperture to control the amount of the first light 134 passing through the aperture. Other mechanisms of generating the thin second light 144a may also be used according to various aspects of the present disclosure.

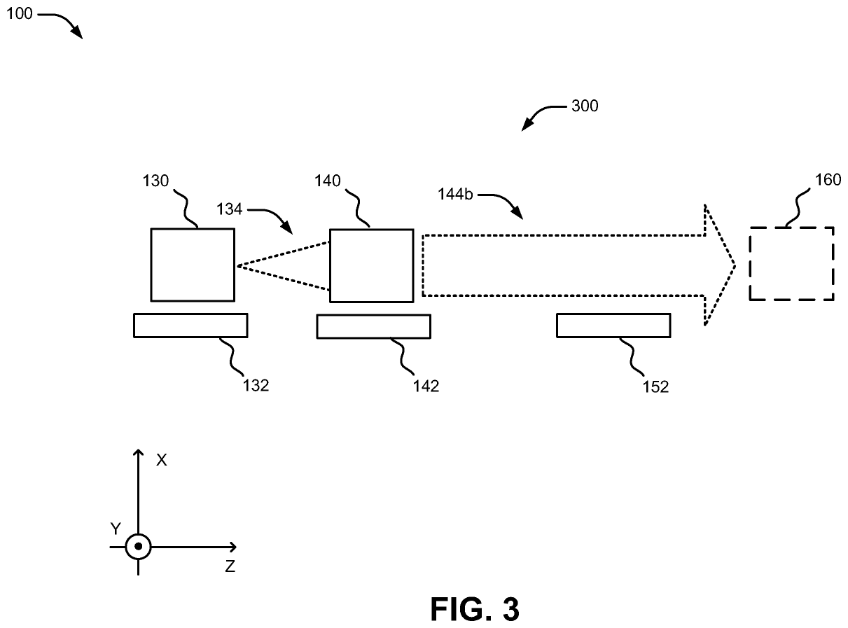

FIG. 3 illustrates a second configuration for aligning the emulation system according to aspects of the present disclosure. A second configuration 300 of the emulation system 100 may be configured for depth alignment. In some aspects of the present disclosure and referring to FIGS. 1 and 3, in the second configuration 300, the first objective 140 may receive the first light 134. The controller 110 may provide one or more mount control signals to the first mount 132 and/or the second mount 142 to align the light source 130 and the first objective 140.

In some aspects, the first objective 140 may include one or more lenses configured to collimate the first light 134 into a thick second light 144b (a collimated beam). The thick second light 144b may be the entire collimated beam exiting the one or more lenses of the first objective 140. In other words, the thick second light 144b may exit the first objective 140 unaltered. The thick second light 144b may have a diameter 10 times, 20 times, 50 times, or 100 times larger than the thin second light 144 a (FIG. 2). The thick second light 144b may be used to align the light source 130 and/or the first objective 140 to the imaging system 160. The thick second light 144b may be used for focal alignment (i.e., along the z-axis or perpendicular to the plane span by the x-axis and the y-axis) by the imaging system 160. In the second configuration 300, the second objective 150 may be removed and/or disabled such that the second objective 150 does not impact the thick second light 144b.

In certain aspects of the present disclosure, the in-plane alignment may be performed before the focal alignment. In other aspects, the focal alignment may be performed before the in-plane alignment.

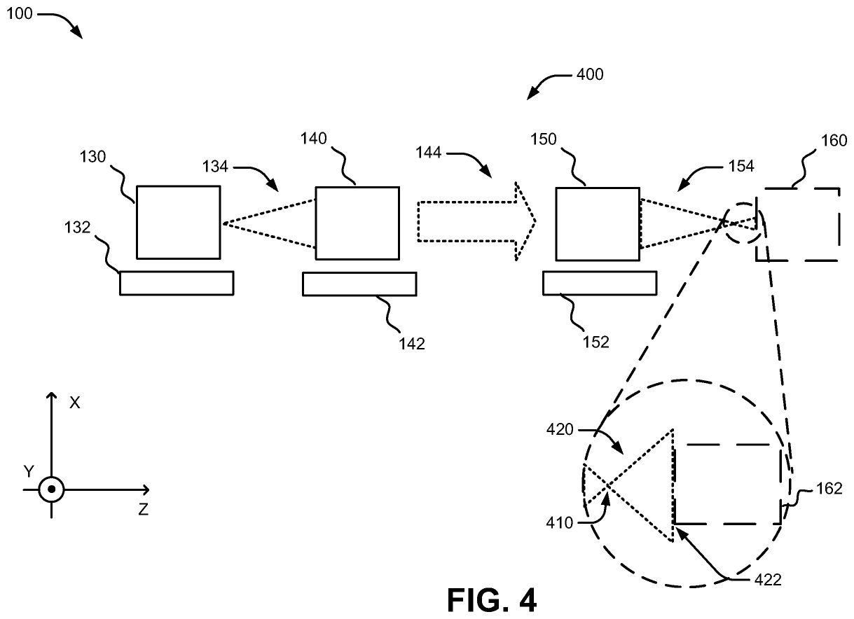

FIG. 4 illustrates a third configuration for emulating an ion according to aspects of the present disclosure. A third configuration 400 of the emulation system 100 may be configured to emit light that simulates a trapped ion emission. The third configuration 400 may allow for the calibration, adjustment, testing, and/or other operations of imaging systems, such as the imaging system 160 (FIG. 1). In one example, the third configuration 400 may allow for the calibration, adjustment, testing, and/or other operations of imaging systems without the need of having a trapped ion system, which include but is not limited to a vacuum chamber, trapped ions, one or more electric field biasing system, pumps, cryogenic components, cryogenic fluid, etc. Instead, the third configuration 400 may provide light that simulates a trapped ion emission.

In some aspects of the present disclosure and referring to FIGS. 1 and 4, in the third configuration 400, the first objective 140 may receive the first light 134. The controller 110 may provide one or more first mount control signals to the first mount 132 and/or the second mount 142 to align the light source 130 and the first objective 140.

In some aspects, the first objective 140 may include one or more lenses configured to collimate the first light 134 into the second light 144 (a collimated beam). The second light 144 may exit the first objective 140 as a collimated beam.

In certain aspects, the controller 110 may provide one or more second mount control signals to one or more of the first mount 132, the second mount 142, and/or the third mount 152 to align the light source 130, the first objective 140, and/or the second objective 150. In one aspect, the controller 110 may leave the first mount 132 and the second mount 142 unperturbed (from the previous alignment) and adjust third mount 152 to align the second objective 152 to the first objective 142.

In aspects of the present disclosure, the controller 110 may insert and/or enable the second objective 150 for the third configuration 400. As such, the second light 144 exiting the first objective 140 may enter the second objective 150. The second objective 150 may include one or more lenses configured to focus the second light 144 (a collimated beam) into the third light 154. The one or more lenses may have a high numerical aperture, such as a numerical aperture of greater than 0.5, 0.6, 0.7, or larger.

In some aspects of the present disclosure, the third light 154 may exit the second objective 150. The one or more lenses in the second objective 150 may focus the third light 154 into a focal point 410. After the focal point 410, the third light 154 may disperse in a triangular shape 420. The focal point 410 may simulate the emission of a trapped ion. Specifically, since a diameter of a trapped ion is much smaller than the wavelength of the light emitted by the trapped ion, the third light 154 after the focal point 410 (emitted in the triangular shape 420) appears as a point source emission from a trapped ion as observed by the imaging system 160.

In some aspect, an input lens 162 of the imaging system 160 may receive the third light 154 after the focal point 410. The input lens 162 may be smaller than an edge 422 of the triangular shape 420. As such, the input lens 162 may observe the third light 154 after the focal point 410 as an light similar to the isotropic emission of a trapped ion. Based on the above, the emulation system 100 may simulate the emission of a trapped ion.

In some aspects, the light source 130, the first objective 140, and/or the second objective 150 may each include one or more of color filters, neutral density filters, apertures, gratings, mirrors, prisms, beam splitters, polarizers, depolarizers, diffusers, lenses, and/or other optical components.

In some aspects, a beam profiler may be used to profile the light source 130.

In certain aspects, one or more of a camera and/or a PG lens of the imaging system 160 may be used to properly adjust the focus of the light form the emulation system 100.

In some aspects, the first mount 132, the second mount 142, and/or the third mount 152 may include one or more nanopositioners.

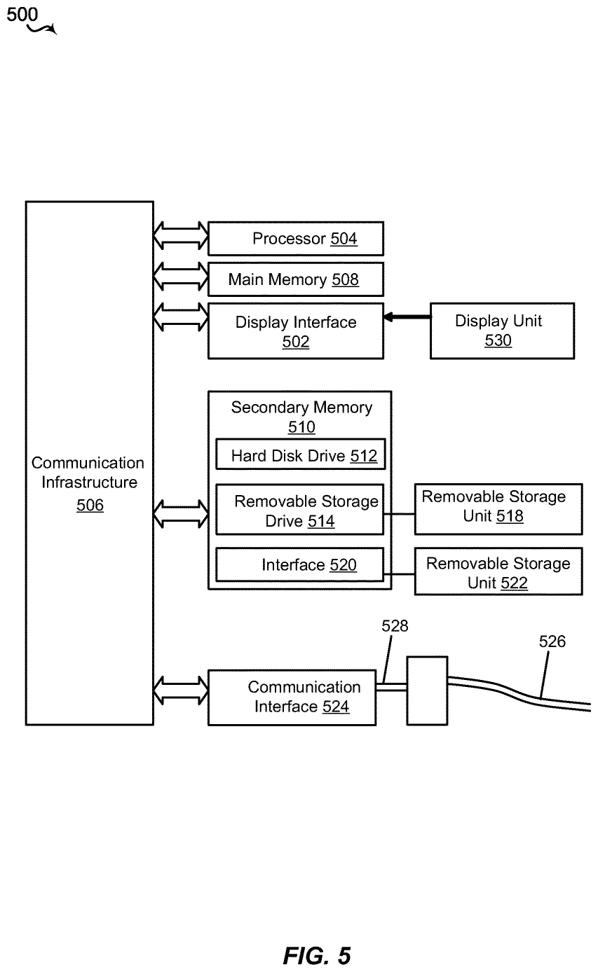

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 500 is shown in FIG. 5. In some examples, the controller 110 may be implemented as the computer system 500 shown in FIG. 5. The controller 110 may include some or all of the components of the computer system 500.

The computer system 500 includes one or more processors, such as processor 504. The processor 504 is connected with a communication infrastructure 506 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 500 may include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512, and/or a removable storage drive 514, representing a floppy disk drive, a magnetic tape drive, an optical disk drive, a universal serial bus (USB) flash drive, etc. The removable storage drive 514 reads from and/or writes to a removable storage unit 518 in a well-known manner. Removable storage unit 518 represents a floppy disk, magnetic tape, optical disk, USB flash drive etc., which is read by and written to removable storage drive 514. As will be appreciated, the removable storage unit 518 includes a computer usable storage medium having stored therein computer software and/or data. In some examples, one or more of the main memory 508, the secondary memory 510, the removable storage unit 518, and/or the removable storage unit 522 may be a non-transitory memory.

Alternative aspects of the present disclosures may include secondary memory 510 and may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and the removable storage unit 522 and the interface 520, which allow software and data to be transferred from the removable storage unit 522 to computer system 500.

Computer system 500 may also include a communications circuit 524. The communications circuit 524 may allow software and data to be transferred between computer system 500 and external devices. Examples of the communications circuit 524 may include a modem, a network interface (such as an Ethernet card), a communications port, a Personal Computer Memory Card International Association (PCMCIA) slot and card, etc. Software and data transferred via the communications circuit 524 are in the form of signals 528, which may be electronic, electromagnetic, optical or other signals capable of being received by the communications circuit 524. These signals 528 are provided to the communications circuit 524 via a communications path (e.g., channel) 526. This path 526 carries signals 528 and may be implemented using wire or cable, fiber optics, a telephone line, a cellular link, an RF link and/or other communications channels. In this document, the terms “computer program medium” and “computer usable medium” are used to refer generally to media such as the removable storage unit 518, a hard disk installed in hard disk drive 512, and signals 528. These computer program products provide software to the computer system 500. Aspects of the present disclosures are directed to such computer program products.

Computer programs (also referred to as computer control logic) are stored in main memory 508 and/or secondary memory 510. Computer programs may also be received via communications circuit 524. Such computer programs, when executed, enable the computer system 500 to perform the features in accordance with aspects of the present disclosures, as discussed herein. In particular, the computer programs, when executed, enable the processor 504 to perform the features in accordance with aspects of the present disclosures. Accordingly, such computer programs represent controllers of the computer system 500.

In an aspect of the present disclosures where the method is implemented using software, the software may be stored in a computer program product and loaded into computer system 500 using removable storage drive 514, hard disk drive 512, or the interface 520. The control logic (software), when executed by the processor 504, causes the processor 504 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

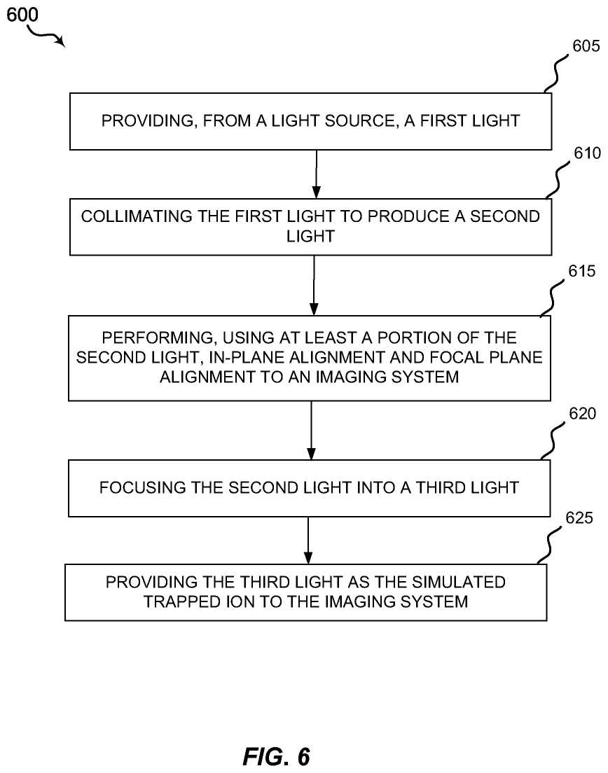

FIG. 6 illustrates an example of a method 600 for simulating a trapped ion according to various aspects of the present disclosure. In some instances, and referring to FIGS. 1-6, the method 600 is performed by one or more of the emulation system 100, the computer system 500, and/or one or more subcomponents of the emulation system 100 or the computer system 500.

At 605, the method 600 includes providing, from a light source, a first light. One or more of the light source 130, the emulation system 100, the computer system 500, and/or one or more subcomponents of the emulation system 100 or the computer system 500 are configured to, and/or provide means for, providing, from a light source, a first light.

At 610, the method 600 includes collimating the first light to produce a second light. One or more of the first objective 140, the emulation system 100, the computer system 500, and/or one or more subcomponents of the emulation system 100 or the computer system 500 are configured to, and/or provide means for, collimating the first light to produce a second light.

At 615, the method 600 includes performing, using at least a portion of the second light, in-plane alignment and focal plane alignment to an imaging system. One or more of the second objective 150, the third mount 152, the emulation system 100, the computer system 500, and/or one or more subcomponents of the emulation system 100 or the computer system 500 are configured to, and/or provide means for, performing, using at least a portion of the second light, in-plane alignment and focal plane alignment to an imaging system.

At 620, the method 600 includes focusing the second light into a third light. One or more of the second objective 150, the third mount 152, the emulation system 100, the computer system 500, and/or one or more subcomponents of the emulation system 100 or the computer system 500 are configured to, and/or provide means for, focusing the second light into a third light.

At 625, the method 600 includes providing the third light as the simulated trapped ion to the imaging system. One or more of the second objective 150, the third mount 152, the emulation system 100, the computer system 500, and/or one or more subcomponents of the emulation system 100 or the computer system 500 are configured to, and/or provide means for, providing the third light as the simulated trapped ion to the imaging system.

Aspects of the present disclosure include a method of providing, from a light source, a first light, collimating the first light to produce a second light, performing, using at least a portion of the second light, in-plane alignment and focal plane alignment to an imaging system, focusing the second light into a third light, and providing the third light as the simulated trapped ion to the imaging system.

Aspects of the present disclosure include the method above, wherein collimating the first light comprises collimating the first light using a first objective.

Aspects of the present disclosure include any of the methods above, wherein focusing the second light comprises focusing the second light using a second objective.

Aspects of the present disclosure include any of the methods above, further comprising adjusting a first position of the light source by moving the light source along a x-axis, a y-axis, and a z-axis, and rotate long the x-axis and the y-axis, adjusting a second position of the first objective by moving the first objective along the x-axis, the y-axis, and the z-axis, and rotate long the x-axis and the y-axis, and adjusting a third position of the second objective move the second objective along the x-axis, the y-axis, and the z-axis, and rotate long the x-axis and the y-axis.

Aspects of the present disclosure include any of the methods above, wherein the first objective includes a collimator and an aperture.

Aspects of the present disclosure include any of the methods above, wherein performing the in-plane alignment comprises collimating, via the collimator, the first light to produce a collimated light, reducing, via the aperture, the collimated light to produce a constricted light, and aligning the constricted light to the imaging system.

Aspects of the present disclosure include any of the methods above, wherein the controller is configured to perform the focal alignment by collimating, via the collimator, the first light to produce the second light and aligning the second light to the imaging system.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. An emulation system for simulating a trapped ion, comprising:
a light source disposed on a first mount and configured to provide a first light;
a first objective disposed on a second mount and having one or more first lenses and an aperture;
a second objective disposed on a third mount and having one or more second lenses; and
a controller having:
one or more memories having instructions;
one or more processors configured to execute the instructions to:
cause the first objective to collimate the first light to produce a second light;
perform in-plane alignment and focal plane alignment to an imaging system using at least a portion of the second light;
cause the second objective to focus the second light into a third light; and
provide the third light as the simulated trapped ion to the imaging system.

2. The emulation system of claim 1, wherein:
the first mount is configured to move along a x-axis, a y-axis, and a z-axis, and rotate long the x-axis and the y-axis;
the second mount is configured to move along the x-axis, the y-axis, and the z-axis, and rotate long the x-axis and the y-axis; and
the third mount is configured to move along the x-axis, the y-axis, and the z-axis, and rotate long the x-axis and the y-axis.

3. The emulation system of claim 2, wherein at least one of the first mount, the second mount, or the third mount includes one or more nanopositioner.

4. The emulation system of claim 2, wherein at least one of the first mount, the second mount, or the third mount includes one or more motors.

5. The emulation system of claim 1, wherein the first objective includes a collimator.

6. The emulation system of claim 5, wherein the controller is configured to perform the in-plane alignment by:
causing the collimator to collimate the first light to produce a collimated light;
causing the aperture to reduce the collimated light to produce a constricted light;
aligning the constricted light to the imaging system.

7. The emulation system of claim 5, wherein the controller is configured to perform the focal alignment by:
causing the collimator to collimate the first light to produce the second light;
aligning the second light to the imaging system.

8. The emulation system of claim 1, further comprising a fiber configured to guide a source light from an emitter to the light source as the first light.

9. The emulation system of claim 8, further comprising a neutral density filter configured to reduce the source light into the first light.

10. The emulation system of claim 1, wherein the aperture is a pinhole aperture.

11. A method of simulating a trapped ion, comprising:
providing, from a light source, a first light;
collimating the first light to produce a second light;
performing, using at least a portion of the second light, in-plane alignment and focal plane alignment to an imaging system;
focusing the second light into a third light; and
providing the third light as the simulated trapped ion to the imaging system.

12. The method of claim 11, wherein collimating the first light comprises collimating the first light using a first objective.

13. The method of claim 12, wherein focusing the second light comprises focusing the second light using a second objective.

14. The method of claim 13, further comprising:
adjusting a first position of the light source by moving the light source along a x-axis, a y-axis, and a z-axis, and rotate long the x-axis and the y-axis;
adjusting a second position of the first objective by moving the first objective along the x-axis, the y-axis, and the z-axis, and rotate long the x-axis and the y-axis; and
adjusting a third position of the second objective move the second objective along the x-axis, the y-axis, and the z-axis, and rotate long the x-axis and the y-axis.

15. The method of claim 12, wherein the first objective includes a collimator and an aperture.

16. The method of claim 15, wherein performing the in-plane alignment comprises:
collimating, via the collimator, the first light to produce a collimated light;
reducing, via the aperture, the collimated light to produce a constricted light;
aligning the constricted light to the imaging system.

17. The method of claim 15, wherein the controller is configured to perform the focal alignment by:
collimating, via the collimator, the first light to produce the second light;
aligning the second light to the imaging system.

18. An emulation system for simulating a trapped ion, comprising:
a first objective disposed on a first mount and having a collimator and an aperture;
a second objective disposed on a second mount and having one or more lenses; and
a controller having:
one or more memories having instructions;
one or more processors configured to execute the instructions to:
cause the first objective to collimate a first light from a light source to produce a second light;
perform in-plane alignment and focal plane alignment to an imaging system using at least a portion of the second light;
cause the second objective to focus the second light into a third light; and
provide the third light as the simulated trapped ion to the imaging system.

19. The emulation system of claim 18, wherein:
the first mount is configured to move along a x-axis, a y-axis, and a z-axis, and rotate long the x-axis and the y-axis;
the second mount is configured to move along the x-axis, the y-axis, and the z-axis, and rotate long the x-axis and the y-axis.

20. The emulation system of claim 18, wherein the controller is configured to perform the in-plane alignment by:
causing the collimator to collimate the first light to produce a collimated light;
causing the aperture to reduce the collimated light to produce a constricted light;
aligning the constricted light to the imaging system.
